(19) United States
(12) Patent Application Publication
(10) Pub. No.: US 2008/0112404 A1
(43) Pub. Date: May 15, 2008

(54) OVERLAY MULTICAST NETWORK ARCHITECTURE AND METHOD TO DESIGN SAID NETWORK

(76) Inventors: Josue Kuri, Ottawa (CA); Ndiata Kalonji, San Francisco, CA (US)

Correspondence Address: THORNE & HALAJIAN;APPLIED TECHNOLOGY CENTER, 111 WEST MAIN STREET, BAY SHORE, NY, 11706, US

(21) Appl. No.: 11/559,952

(22) Filed: Nov. 15, 2006

(51) Int. Cl. H04L 12/26

(52) U.S. Cl. 370/389

(57) ABSTRACT

A multicast network for multicast services, said network comprising a wide area network comprising core routers handling data traffic inside said wide area network and edge routers handling said data traffic between said core routers and clients to said wide area network, an overlay network comprising overlay core routers handling data traffic inside said overlay network and overlay edge routers handling said data traffic between said overlay core routers and clients to said overlay network, wherein the overlay core routers are highly interconnected, the overlay core routers are connected to the overlay edge routers with a limited number of links; the overlay core routers being collocated with the core routers, and the overlay edge routers being collocated with the edge routers.

### FIELD OF THE PRESENT SYSTEM

The present system generally relates to infrastructure-based overlay networks, and more specifically to such networks adapted for multicast services.

### BACKGROUND OF THE PRESENT SYSTEM

With the popularity of Peer-to-Peer systems, the more general concept of overlay network has emerged in recent years as a flexible approach to support new communication services without requiring costly and risky upgrades of an IP (internet protocol) networking infrastructure. Well-known examples of overlay networks include not only P2P systems such as Gnutella and Kazaa, but also content distribution networks like Akamai and experimental networking platforms such as PlanetLab.

An overlay network is a computer network which is built on top of another network. Nodes in the overlay can be thought of as being connected by virtual or logical links, each of which corresponding to a path, perhaps through many physical links, in the underlying network. The nodes can be located exclusively in the user space (e.g., P2P systems), in the service provider space, or in both. An overlay network whose nodes are located exclusively in the service provider space is known as a proxy-based or infrastructure-based overlay network. The links in an overlay network are typically TCP (Transmission Control Protocol) connections or, more generally, IP-encapsulated unicast flows between pairs of routers.

In computer networks, unicast is the delivery of information packets to a single destination. Multicast corresponds to the delivery of information to a group of destinations and/or users simultaneously using the most efficient strategy to transfer the data over the network only once creating copies only when the links to the destinations split.

The functionality required to offer a multicast service (group management, routing, packet replication, etc.) can be implemented either in the IP layer (the IP multicast approach), or above, in an overlay network. In an overlay network, the functionality can be implemented in the user space, in the service provider space, or in both.

In IP networking, Quality of Service (QoS) and multicast are the most significant features that have been added to the IP layer since its original design, and most routers today implement them. While QoS has been progressively deployed by service providers, mainly to protect sensitive traffic (e.g., Voice over IP), the deployment of multicast has been hampered by complexity and scalability concerns. By scalability, one may understand the ability of a system or a network to either handle growing workloads, or to be easily enlarged. IP multicast indeed requires routers to maintain per-group state, “per-group state” referring to an entry in a table kept by each router, which indicates, for a multicast address, the set of outgoing router interfaces a packet with that address has to be sent to. A large number of groups means a large number of entries to maintain in the table), which introduces high management complexity and scaling constraints.

Overlay multicast systems implemented exclusively in the user space are an interesting alternative to IP multicast, since multicast capabilities do not need to be supported in the IP infrastructure for the service to be provided. This means that the deployment of the service is very flexible and can cover a large geographical area in a short time. Moreover, being implemented in the user space, these systems can leverage application intelligence to simplify functions such as error and congestion control. The drawbacks of end-system (or application-level) overlay multicast systems are, however, that the multicast functionality is implemented in relatively unreliable nodes (commodity user equipment) and that interconnection typically relies on best effort Internet connectivity. These issues often result in network performance unsuitable for streaming applications, arguably the most likely users of multicast services.

In an infrastructure-based multicast overlay network, the nodes implementing the multicast functionality are reliable purpose-built equipment managed by a service provider. Their interconnection relies on SLA (Service Level Agreement) backed IP connectivity supplied by one or more service providers. In addition to the flexibility of end-system overlay multicast systems, an infrastructure-based multicast overlay network provides higher reliability, better performance and efficient use of network resources. Moreover, if the overlay network is designed for a large user base, the service provider can take advantage of the possible economies of scale of a large deployment.

To optimize the links of a network architecture, several objectives may be sought after, for example minimizing end-to-end latency (ETEL) and minimizing the cost of the multicast trees constructed on this architecture, as described in “Multicast Service Overlay Design by Li Lao, Jun-Hong Cui, and Mario Gerla”. The authors nevertheless suggest that these two objectives cannot be satisfied simultaneously. After the overlay proxy servers are located, a separate optimization of each here above mentioned criterion leads to the disclosure of a multicast network architecture for multicast services using proxy servers as switching nodes.

With objectives successively optimized, the resulting network architecture cannot be optimal.

### SUMMARY OF THE PRESENT SYSTEM

It is an object of the present system to overcome disadvantages and/or make improvements in the prior art.

It is a further object of the present system to propose a network architecture that allows to achieve lower Operational Expenditure (OPEX) and Capital Expenditure (CAPEX).

To that extend, the present system includes a multicast network for multicast services. In accordance with an embodiment of the present system, the overlay network architecture for multicast services is built on an underlying wide area network, said overlay network architecture comprising overlay core routers handling data traffic inside said overlay network, and overlay edge routers handling said data traffic between said overlay core routers and clients of said overlay network, wherein the overlay core routers are highly interconnected, and the overlay edge routers are connected to the overlay core routers with a limited number of links.

The proposed network has the property of shifting the bulk of the multicast replication effort from the overlay edge routers to the overlay core routers.

Furthermore, the goal of this design is to reduce the overall cost of switching and transmission required to implement a multicast service using the multicast overlay network according to the present system. Such a network can be built using commercially available equipment and deployed over existing service provider networks. Thanks to such an architecture, the number of links is considerably reduced (when compared to the number of links in an architecture comprising only overlay edge routers connected in a full mesh topology), which leads to less management overhead (i.e. commissioning, provisioning and monitoring).

In accordance with an additional embodiment of the present system, the underlying network comprises an underlying network core and an underlying network access, the overlay core routers being collocated with the underlying network core, and the overlay edge routers being collocated with the underlying network access. Thus the link stress (explained later) is transferred from the access to the core of the wide area network, where switching and transmission costs are lower due to economies of scale.

In accordance with a further embodiment of the present system, the highly interconnected overlay core routers are characterized by an interconnection ratio between said overlay core routers defined by:

D≧0.80

wherein:

$$D = \frac{T}{{T}_{C}}$$

with:
T the total number of links between the overlay core routers,
T_{C} the largest possible number of links between said overlay core

$${T}_{C} = \frac{{N}_{C} ( {N}_{C} - 1 )}{2}$$

routers, and N_{C} the number of overlay core routers.

In accordance with an additional embodiment of the present system, D≧0.90.

In accordance with an additional embodiment of the present system, the overlay core routers are connected in full mesh corresponding to D=1.

In one embodiment of the present system, each overlay edge router is connected to less then 4 overlay core routers.

In accordance with another embodiment of the present system, each overlay edge routers is connected to two overlay core routers.

### BRIEF DESCRIPTION OF THE DRAWINGS

The present system is explained in further detail, and by way of example, with reference to the accompanying drawings wherein:

FIG. 1 shows an exemplary hierarchical network architecture for a multicast overlay network,

FIG. 2 shows an illustrative flat network architecture for a multicast overlay network,

FIG. 3 shows a graph of the percentage of reduction in links in the hierarchical architecture in a first embodiment of the present system, as a function of the number of edge routers,

FIG. 4 illustrates an example of an edge router load on its network facing side,

FIG. 5 illustrates a graph of the edge router overload and offload induced by the hierarchical architecture in the first embodiment of the present system, as a function of the total number edge routers,

FIG. 6 is a graph that illustrates the relationship between available bandwidth and bandwidth cost,

FIG. 7 illustrates an example of a link stress,

FIG. 8 shows a graph of the percentage of reduction in links in the hierarchical architecture in an additional embodiment of the present system, as a function of the number of edge routers, and

FIG. 9 shows a graph of the percentage of reduction in edge router load in the hierarchical architecture in said additional embodiment, as a function of the number of edge routers.

### DETAILED DESCRIPTION OF THE EMBODIMENTS

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims. Moreover, for the purpose of clarity, detailed descriptions of well-known devices, systems, and methods are omitted so as not to obscure the description of the present system. In addition, it should be expressly understood that the drawings are included for illustrative purposes and do not represent the scope of the present system.

In accordance with the present system, the proposed network is defined in terms of the different types of routers required, the topology prescribed for their interconnection, and the location of the routers relative to the underlying wide area infrastructure.

Different choices of equipment, topology and location result in different levels of service quality for customers and cost for the operator. A guiding principle in network design is the support of high quality services at the lowest possible cost in terms of CAPEX and OPEX. Additionally, the network must be resilient and scalable in the sense that increasing its capacity and/or coverage should not result in disproportionate CAPEX and OPEX increases.

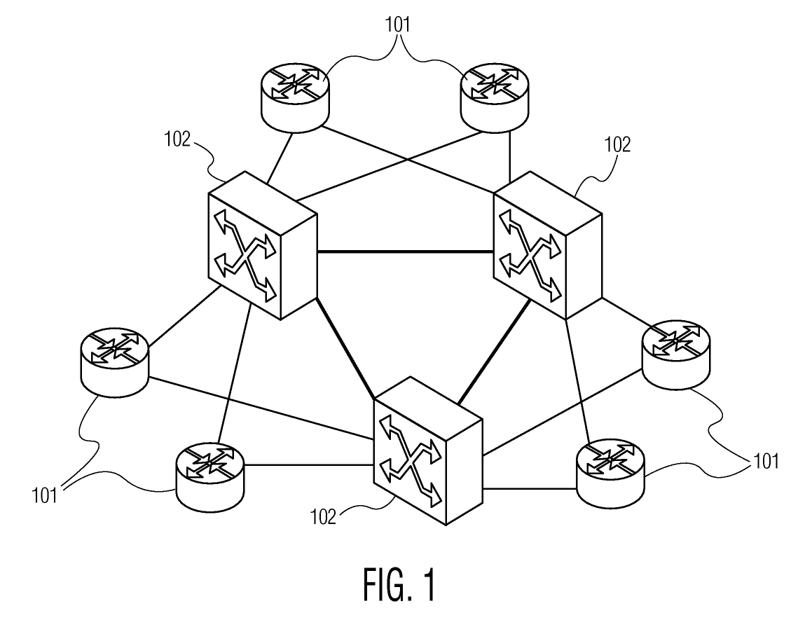

FIG. 1 illustrates an exemplary embodiment of the network according to the present system. Two types of overlay routers are defined at the overlay network level:
an overlay edge router 101. The role of the overlay edge routers 101 is to aggregate traffic coming from Customer Premises Equipment (CPE) or end-user proxies, feed this traffic into the network and, in the reverse direction, forward the traffic from the network to the CPE and end-user proxies. Overlay edge routers 101 have thus a “customer-facing” and a “network-facing” side.
An overlay core router 102. Overlay core routers 102 on the other hand are responsible for forwarding transit traffic between overlay edge routers 101 (neither CPE nor end-user proxies are attached to them). Overlay core routers may be also linked to other core routers.

In other words, the overlay core routers handle data traffic inside the overlay network, while overlay edge routers handle said data traffic between the overlay core routers and clients of the overlay network.

In the network according to the present system, the overlay network comprises a plurality of overlay core routers and overlay edge routers. The overlay network is built on top of a wide area network (not shown in FIG. 1), which itself comprises a core, or underlying network core and an access, or underlying network access. This wide area network will also be hereafter referred to as the underlying network. It may be for example (but not limited to) the Internet, or another IP (Internet Protocol) network.

Furthermore, in the overlay network according to the present system, the overlay core routers are highly interconnected, and the overlay edge routers are connected to the overlay core routers with a limited number of links. This network architecture will be referred to, here after, as a hierarchical architecture.

In an additional embodiment of the network according to the present system, the overlay core routers are collocated in the underlying network core, and the overlay edge routers are collocated in the underlying network access.

In the example of FIG. 1, the overlay core routers 102 are connected in full mesh, while the overlay edge routers 101 are connected to two overlay core routers. This is a particular and exemplary embodiment of the network according to the present system as it presents the most connection within the overlay core and the number of links between one overlay edge router and overlay core routers is limited to exactly 2.

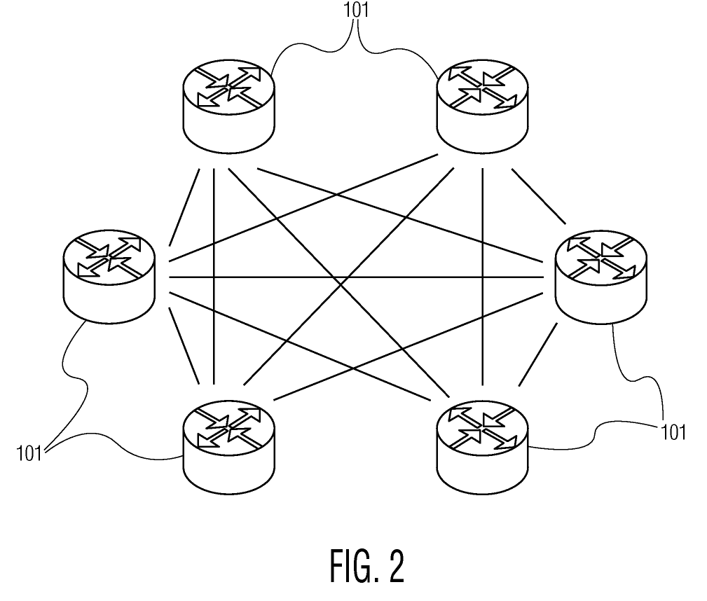

To determine the types of routers, their location as well as the topology of the overlay network according to the present system (that can result in potentially higher service quality and lower OPEX and CAPEX), we first will compare the hierarchical overlay architecture, as the exemplary architecture of FIG. 1, to the known flat architecture of FIG. 2. The conclusions will then be generalized to the hierarchical overlay network according to the present system, wherein the overlay core routers are highly interconnected and each overlay edge router has a limited connectivity to the overlay core routers.

In the alternative flat architecture, the overlay edge routers 101 form a flat network and are interconnected through a full mesh of links. There are no core routers, i.e. such a network is structured in such a way that it does not have a network core. This type of architecture is used in known overlay networks like OMNI (as described in S. Banerjee, C. Kommareddy, K. Kar, B. Bhattacharjee and S. Khuller, “Construction of an efficient overlay multicast infrastructure for real-time applications,” in Proceedings of IEEE Infocom 2003, San Francisco, Calif., March-April 2003), AMcast (from S. Shi and J. Turner, “Routing in overlay multicast networks,” in Proceedings of IEEE Infocom 2002, New York, N.Y. June 2002) and RON (from D. Andersen, H. Balakrishnan, M. Kaashoek and R. Morris, “Resilient Overlay Network,” in Proceedings of ACM SOSP 2001, Banff, Canada, October 2001), or even in standardized architectures like VPLS (as known from P. Knight and C. Lewis, “Layer 2 and Layer 3 virtual private networks taxonomy, technology and standardization efforts,” in IEEE Communications Magazine, Volume 42, Issue 6. June 2004).

We first compare the number of overlay links required in the hierarchical architecture as illustrated in FIG. 1 and the flat architecture as illustrated in FIG. 2. Since every link involves management overhead (commissioning, provisioning and monitoring), the smaller number of links in the hierarchical architecture results in lower OPEX.

Let N_{E} be the number of overlay edge routers, N_{C} the number of overlay core routers and

$$α = \frac{{N}_{E}}{{N}_{C}}$$

the number of overlay edge routers per overlay core router. The number of (bidirectional) links required in the exemplary hierarchical architecture of FIG. 1 is:

$${μ}_{H} ( {N}_{E} , {N}_{C} ) = 2 {N}_{E} + \frac{{N}_{C} ( {N}_{C} - 1 )}{2}$$

The number of links required in the flat architecture of FIG. 2 is:

$${μ}_{F} ( {N}_{E} ) = \frac{{N}_{E} ( {N}_{E} - 1 )}{2}$$

Finally, the reduction in links provided by the hierarchical architecture with respect to the flat architecture is:

$$θ ( {N}_{E} , {N}_{C} ) = 1 - \frac{{μ}_{H} ( {N}_{E} , {N}_{C} )}{{μ}_{F} ( {N}_{E} )}$$

Asymptotically, the reduction in links for a constant value of α is:

$${lim}_{{N}_{E} -> ∞} θ ( {N}_{E} , \frac{{N}_{E}}{α} ) = \frac{{α}^{2} - 1}{{α}^{2}}$$

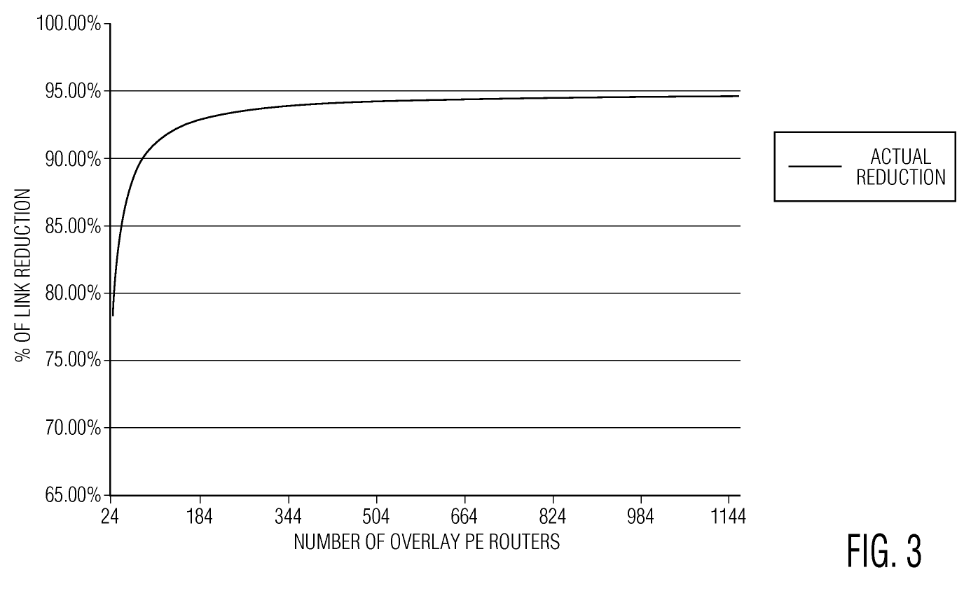

Clearly, the reduction in links approaches 100% as α increases. FIG. 3 shows the reduction in links as a function of the number of overlay edge routers for a constant α=4. The reduction in links approaches 93.75% as N_{E} increases.

From a data plane perspective, an interesting characteristic of the flat architecture is that a direct overlay link exists between any pair of overlay edge routers. This direct connectivity eliminates the need for transit routers (i.e. core routers) and the latency induced by them. The down side of the flat architecture is, however, that replication of multicast traffic has to be performed exclusively by the originating edge router, which means that a very high throughput might be required in this equipment.

In the hierarchical architecture of FIG. 1, since an overlay edge router is connected to only two overlay core routers, the traffic entering the network through this router is replicated at most twice, which is much less than up to N_{E}−1 replications required in the flat architecture. The bulk of the replication effort is thus shifted from the overlay edge routers to the overlay core routers, which are connected in full mesh among themselves. However, the hierarchical architecture introduces one or two intermediate overlay core routers between any pair of overlay edge routers, which means that, overall, more switching has to be performed in such a network.

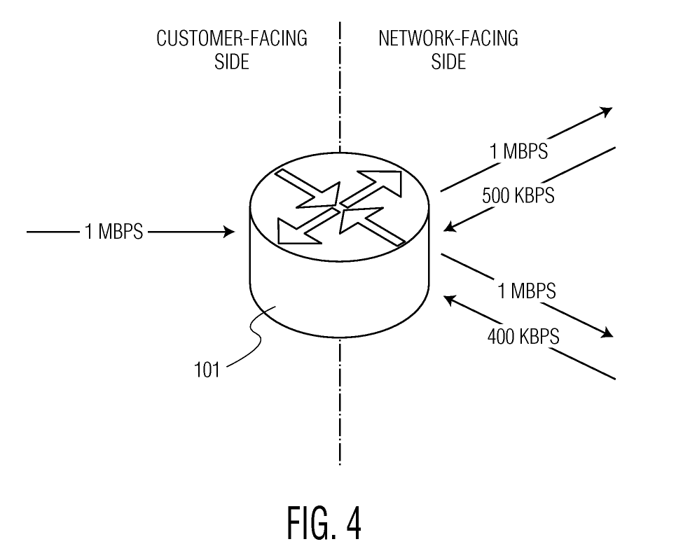

In the following paragraphs we will quantitatively relate the “offload” (i.e., reduction of the amount of traffic that must be handled) in the overlay edge routers to the overall “overload” (i.e. amount of additional switching capacity required in the network) induced by the hierarchical architecture as illustrated in FIG. 1 to assess the cost/benefit trade-off of this architecture. For this, we first introduce the concepts of overlay edge router load and overlay core router load. The former refers to the volume of traffic (in bits per second) that must be handled by the network-facing side (facing the core routers) of an overlay edge router. This load includes the volume of traffic sent to and received from the overlay network. In the example of FIG. 4, the overlay edge router 101 load is 2.9 Mbps, which includes the 2 Mbps of outgoing traffic and the 900 Kbps of incoming traffic on the network-facing side. The incoming and outgoing traffic on the customer-facing side is not considered since this volume of traffic is the same for the flat and the hierarchical architectures.

The overlay core router load refers to the volume of incoming and outgoing traffic in an overlay core router. Assuming that each overlay edge router receives one unit of traffic (e.g., 1 Mbps) from its customer-facing side, and that this traffic must be received by the other N_{E}−1 overlay edge routers, the overlay core router load is in the exemplary architecture of FIG. 1:

$${Q}_{H} ( {N}_{E} , {N}_{C} ) = 2 \frac{{N}_{E}}{{N}_{C}} ( 1 + \frac{{N}_{C} - 2}{2} ) + \frac{{N}_{E} ( {N}_{E} - 1 )}{{N}_{C}}$$

and the total load in the overlay P routers is:

φ_{H}(N_{E}, N_{C})=N_{C}·Q_{H}(N_{E}, N_{C})

Under this assumption, the overlay edge router load in the hierarchical architecture is:

ρ_{H}(N_{E})=2+N_{E}−1

and the total load in the overlay edge routers of a hierarchical network is:

φ_{H}(N_{E})=N_{E}·ρ_{H}(N_{E})

Similarly, the overlay edge router load in the flat architecture is:

ρ_{F}(N_{E})=2(N_{E}−1)

and the total load in the overlay edge routers of a flat network is:

φ_{F}(N_{E})=N_{E}·ρ_{F}(N_{E})

The overlay edge router offload induced by the hierarchical architecture is:

$$γ ( {N}_{E} ) = \frac{{ρ}_{F} ( {N}_{E} ) - {ρ}_{H} ( {N}_{E} )}{{ρ}_{F} ( {N}_{E} )} = 1 - \frac{1}{2} \frac{{N}_{E} + 1}{{N}_{E} - 1}$$

and its asymptotic value is:

$${lim}_{{N}_{E} \to ∞} γ ( {N}_{E} ) = \frac{1}{2}$$

γ(N_{E}) corresponds to the asymptotic reduction in overlay edge router load in the hierarchical architecture according to the present system when compared to the flat architecture.

On the other hand, the overload induced by the hierarchical architecture is:

$$κ ( {N}_{E} , {N}_{C} ) = \frac{{φ}_{H} ( {N}_{E} ) + {ϕ}_{H} ( {N}_{E} , {N}_{C} ) - {φ}_{F} ( {N}_{E} )}{{φ}_{F} ( {N}_{E} )}$$

and its asymptotic value for a constant α is:

$${lim}_{{N}_{E} \to ∞} κ ( {N}_{E} , \frac{{N}_{E}}{α} ) = \frac{1}{2 α}$$

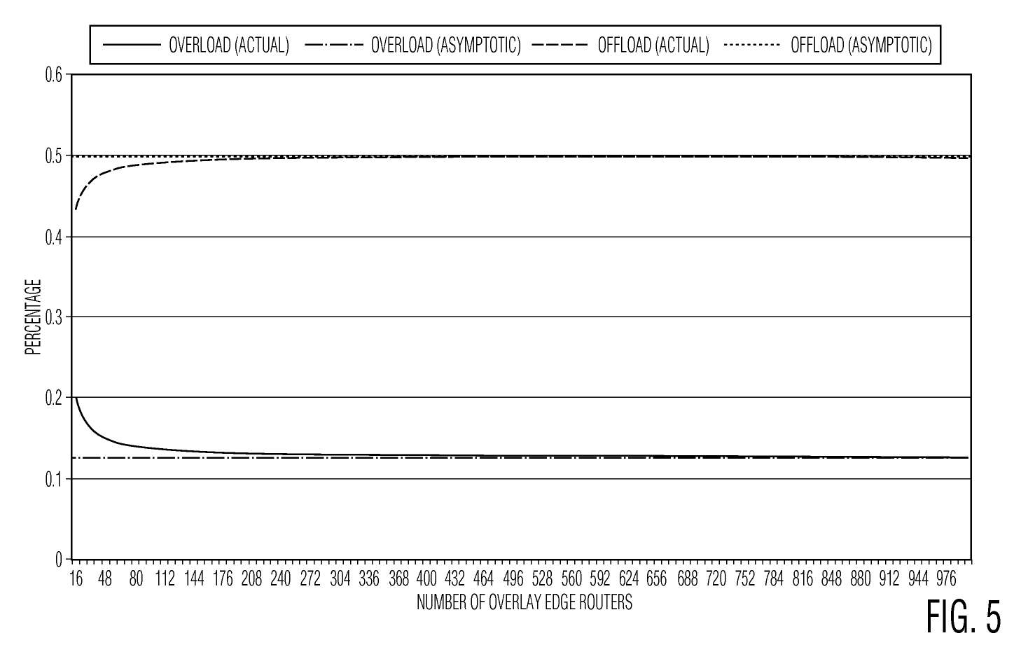

FIG. 5 shows the overlay edge router offload and the overall overload induced by the hierarchical architecture for a constant α=4. The overload of 12.5% in this case is economically reasonable considering that introducing 4 additional overlay edge routers to increase the network coverage requires only one overlay core router to maintain the overlay core router load constant. In a large network, the overload tends to be limited to ½α, and can be controlled provided α is large. With ≢=3, the overload is limited to 16.67% for a large network.

The hierarchical architecture according to the present system has furthermore the effect of shifting both the replication effort from the overlay edge to the overlay core routers, and the link stress (explained here after) from the access links to the core links of the underlying wide area network.

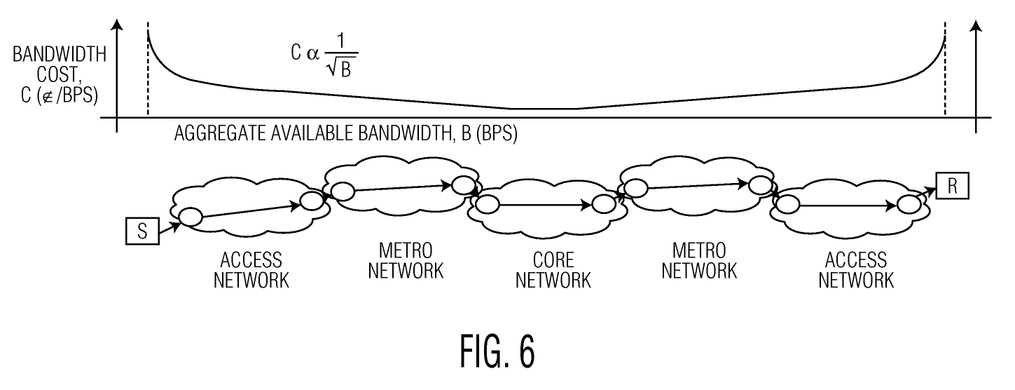

The goal is to leverage the economies of scale in the core routers and links of the underlying network. These economies of scale result in switching and transmission being cheaper in the core than in the access of the underlying layer, as explained in “Commercial models for IP Quality of Service Interconnect” from B. Briscoe and S. Rudkin, published in BT Technical Journal, Special Edition in IP Quality of Service, 23(2). April 2005. This is due to the inherent geographic dispersion of access networks, which results in higher CAPEX and OPEX in the access. This phenomenon is illustrated in FIG. 6, as taken from “Commercial models for IP quality of service Interconnect”. The bandwidth cost is plotted as a function of the network location. The bandwidth cost reaches a lowest value at the core of the underlying network. By aggregate available bandwidth, Bone may understand the total capacity available in one part of the network.

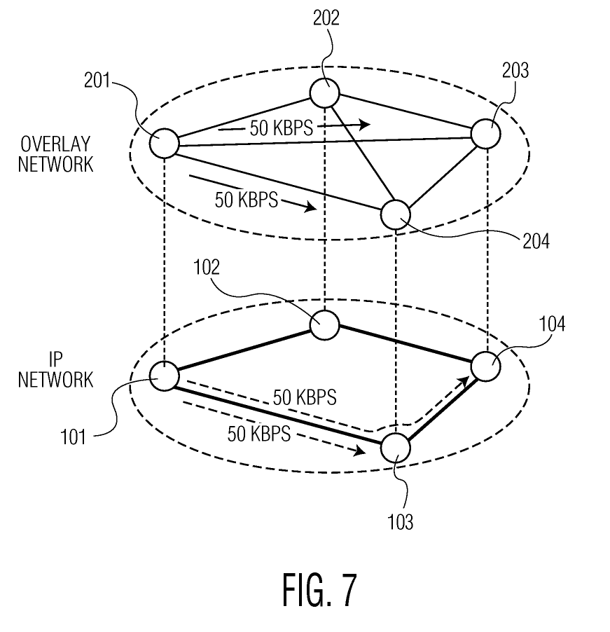

Link stress refers to the redundant copies of the same information sent over a same underlying link. Link stress occurs when the same information is sent over two or more overlay links, and these links traverse the same underlying link. The concept is illustrated in FIG. 7, with the example of overlay core routers and the core of the underlying network. Link stress may also occur in the access of the underlying network. The overlay network comprises 4 cores routers 201 to 204, connected in a full mesh. The underlying network core comprises 4 routers 301 to 304 connected in a ring: 301 is connected to 302 and 303 and 304 is also connected to 302 and 303. A 50 Kbps flow is sent from overlay router 201 to overlay routers 203 and 204 over two different overlay links 201 to 203 and 201 to 204. Both overlay links share the 301 to 303 link in the underlying network. This results in two copies of the same information being sent over the 301 to 303 underlying link.

The link stress tends to increase when the connectivity of the overlay network is much higher than the connectivity of the underlying network. This is the case, for example, of an overlay network with a full mesh topology instantiated over an underlying network with a ring topology. Link stress is likely to occur in these situations because more overlay links cross a same underlying link.

In the exemplary hierarchical architecture of FIG. 1, link stress is more likely to occur in the core of the underlying network than in the access links because the overlay core routers are connected in full mesh, while the underlying network core may not. The shift of link stress to the core is in fact a desirable property of the proposed architecture: If link stress has to occur, it is better to have it in the core of the underlying network, where switching and transmission are cheaper than in its access (periphery of the underlying network).

In the exemplary hierarchical architecture of the overlay network according to the present system, less overlay links are required than in the flat architecture (as shown before and illustrated in FIG. 3 for α=4), which results in potentially lower OPEX. Furthermore, thanks to the number of links between a overlay edge router with overlay core routers limited to 2, the proposed network is resilient to access link failures. It is also easier to add a new overlay edge router since it only has to be connected to 2 overlay core routers, instead of N_{E}−1, as in the flat architecture. Replication and link stress are shifted to the core of the network, where switching and transmission of traffic are cheaper. The intra-core traffic through the overlay core routers is non existent as the overlay core routers are connected in a full mesh. The regularity of the topology makes the overlay edge routers only 2 or 3 hops away from each other.

In a more general approach, in the hierarchical overlay network according to the present system, the overlay core routers are highly interconnected and the overlay edge routers are connected to a limited number of overlay core routers.

To define highly interconnected, an interconnection ratio D of the overlay core routers may be defined by:

$$D = \frac{T}{{T}_{C}}$$

where:
T is the total number of bidirectional links between the overlay core routers, and
T_{C} is the largest possible number of bidirectional links between said overlay core routers,

$${T}_{C} = \frac{{N}_{C} ( {N}_{C} - 1 )}{2} .$$

The lowest value of D is reached when the overlay core routers are

connected as a ring. Thus

$$\frac{2}{{N}_{C} - 1} \leq D \leq 1.$$

We use parameter M to indicate the number of overlay core routers an overlay edge router is connected to. The parameter can take values in the range [1,N_{c}].

With D=1 and H=2, the overlay architecture corresponds to the exemplary hierarchical architecture of FIG. 1.

We now measure the reduction in links and the reduction of the overlay edge router load provided by the hierarchical architecture with different values of D and M (i.e., not necessarily D=1 and M=2).

The number of bidirectional links required in the flat architecture is:

$${μ}_{F} ( {N}_{E} ) = \frac{{N}_{E} ( {N}_{E} - 1 )}{2}$$

The number of bidirectional links required in the overlay network according to the present system is:

$${μ}_{H}^{*} ( {N}_{E} , {N}_{C} , M , D ) = {MN}_{E} + D \frac{{N}_{C} ( {N}_{C} - 1 )}{2}$$

The reduction in links provided by the overlay network according to the present system with respect to the flat architecture is:

$${θ}^{*} ( {N}_{E} , {N}_{C} , M , D ) = 1 - \frac{{μ}_{H}^{*} ( {N}_{E} , {N}_{C} , M , D )}{{μ}_{F} ( {N}_{E} )}$$

Asymptotically, the reduction in links for a constant value of α is:

$${lim}_{{N}_{E} \to ∞} {θ}^{*} ( {N}_{E} , \frac{{N}_{E}}{α} , M , D ) = 1 - \frac{D}{{α}^{2}}$$

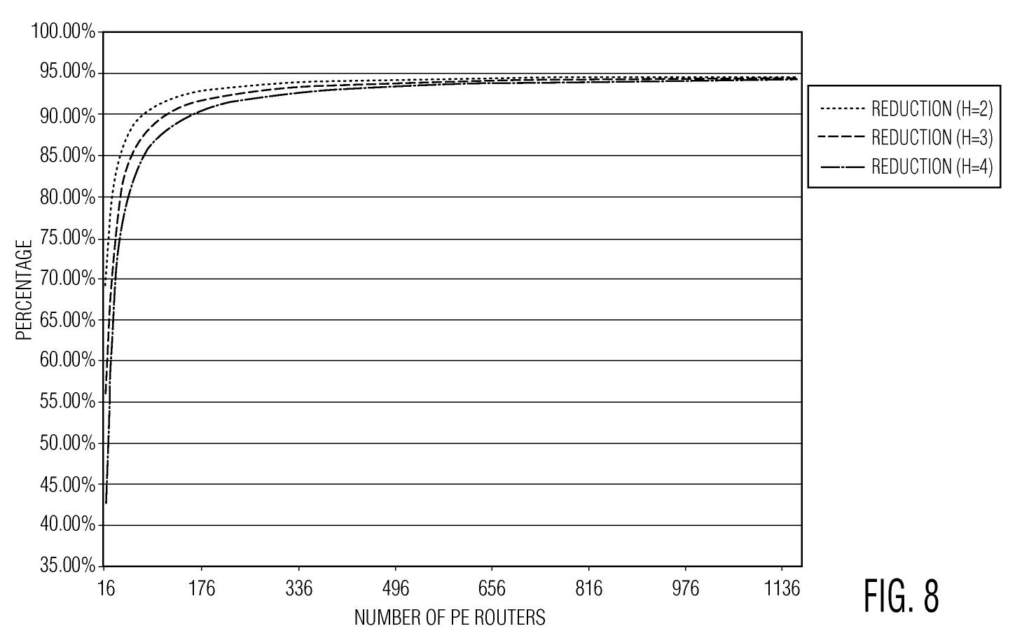

One may note that the limit is independent of M. FIG. 8 shows the reduction in links for M=2, 3 and 4, D=0.8 and α=4. Asymptotically, the reduction in number of links in this case is 95%, which is higher than the 93.75% of the exemplary embodiment of FIG. 1.

The overlay edge router load in the overlay network according to the present system is:

ρ*_{H}(N_{E},M)=M+N_{E}−1

Similarly, the overlay edge router load in the flat architecture is:

ρ_{F}(N_{E})=2(N_{E}−1)

The reduction of overlay edge router load induced by the overlay network according to the present system is:

$${γ}^{*} ( {N}_{E} , H ) = \frac{{ρ}_{F} ( {N}_{E} ) - {ρ}_{H}^{*} ( {N}_{E} , H )}{{ρ}_{F} ( {N}_{E} )} = 1 - \frac{1}{2} ( \frac{{N}_{E} + H - 1}{{N}_{E} - 1} )$$

and its asymptotic value is:

$${lim}_{{N}_{E} \to ∞} {γ}^{*} ( {N}_{E} , H ) = \frac{1}{2}$$

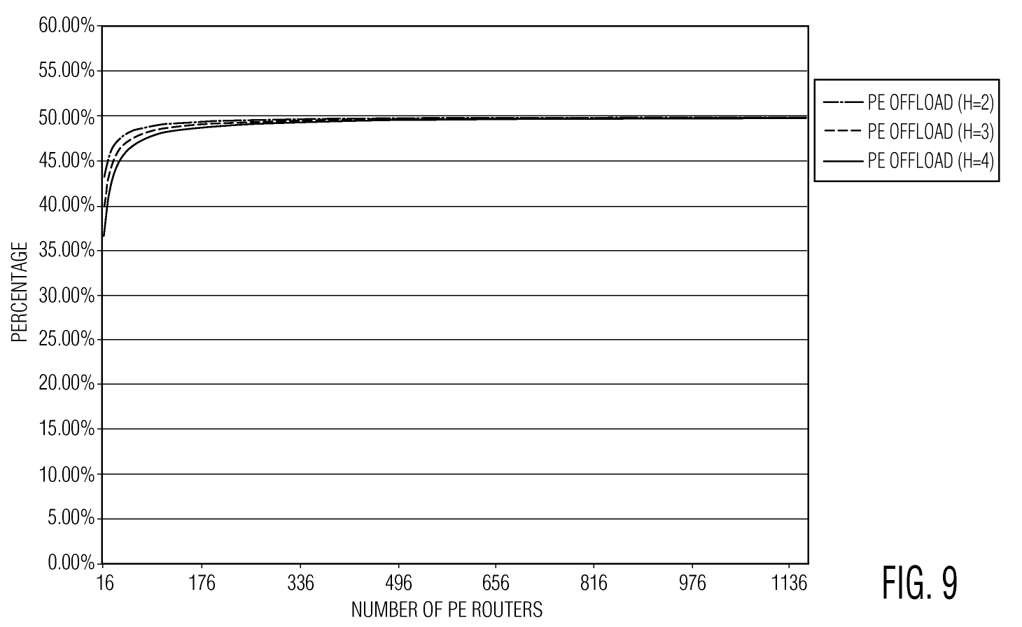

The asymptotic value is independent of parameter M. FIG. 9 shows the reduction in overlay edge router load for M=2, 3 and 4, D=0.8 and α=4. The asymptotic reduction of overlay edge router load is 50%, as for exemplary embodiment of FIG. 1.

Parameter D impacts the reduction in links (and hence OPEX), while parameter M impacts the replication effort in the overlay edge routers according to the present system. A small value of M means low replication effort, and a value close to N_{C} a high replication effort, which requires high-capacity overlay edge routers, and hence, high CAPEX. An interesting value within the scope of this present system is M≦5 to limit this effort.

In the hierarchical network according to the present system, since an overlay edge router is connected to a limited number M of overlay core routers, the traffic entering the network through this router is replicated at most M times, which is much less than up to N_{E}−1 (provided M<N_{E}) replications required in the flat architecture. The bulk of the replication effort is thus shifted from the overlay edge routers to the overlay core routers, which are highly interconnected among themselves.

Furthermore, less overlay links are required than in the flat architecture, which results in potentially lower OPEX and, thanks to the limited number of links between an overlay edge router and overlay core routers, the proposed network is resilient to access link failures. It is also easier to add a new overlay edge router since it only has to be connected to a limited number of overlay core routers, instead of N_{E}−1, as in the flat architecture.

As explained before for the exemplary embodiment of FIG. 1, link stress is also likely to happen with the hierarchical overlay network according to the present system as the overlay core routers are likely to be more interconnected than the underlying network core. The shift of link stress to the core is in fact a desirable property of the proposed architecture as switching and transmission are cheaper than in its access. The intra-core traffic through the overlay core routers is limited (inexistent when D=1) thanks to the high interconnectivity. The regularity of the topology makes the overlay edge routers to be only a few hops away from each other.

In an additional embodiment of the hierarchical architecture of the overlay network according to the present system, the overlay edge routers are collocated with the underlying network edge routers and the overlay core routers are collocated with the underlying network core routers. The collocation allows a reduction in propagation delay between overlay and underlying network routers.

To deploy the overlay multicast network according to the present system in a service provider environment (i.e. infrastructure based network) for example, a network planner has to make a certain number of decisions including (but not limited to):
the number and location of the overlay edge routers,
the number and location of the overlay core routers,
the limited number of overlay core routers each overlay edge router must be connected to,

The number and location of the overlay edge routers depends on both the expected geographical coverage of the offered multicast service and the available sites with underlying network edge routers in which the overlay edge routers could be collocated.

The number and location of the overlay core routers depends on the volume and spatial distribution of traffic expected from the overlay edge routers, the maximum load that an overlay core router is able to handle with acceptable levels of latency, packet loss, etc., and the available sites with underlying network core routers in which the overlay P routers could be collocated.

Finally, the limited number of overlay core routers each overlay edge router must be connected to depends on the latency of the underlying network links connecting the overlay edge router to each candidate overlay core router and the volume of traffic sent by the overlay edge router to the network. Indeed, it might be counterproductive to connect an overlay edge router to a physically close overlay core router with the aim of reducing latency if the overlay core router becomes overloaded and induces significant latency.

To design the overlay network according to the present system, the network planner with take into account objectives that may be cost-oriented, performance-oriented or a combination of both. Cost-oriented objectives are typically related to the minimization of the CAPEX and OPEX required to deploy, expand and operate the network. Performance-oriented objectives include, for example, the minimization of the latency between overlay edge routers, congestion, packet loss, or load in the underlying network.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

What is claimed is:

1. An overlay network for multicast services, said overlay network being built on an underlying wide area network, said overlay network comprising:
overlay core routers handling data traffic inside said overlay network, and;
overlay edge routers handling said data traffic between said overlay core routers and clients to said overlay network,
wherein:
the overlay core routers are highly interconnected,
each overlay edge router is connected to a limited number of overlay core routers.

2. The network of claim 1, wherein the underlying network comprises an underlying network core and an underlying network access, the overlay core routers being collocated in the underlying network core, and the overlay edge routers being collocated in the underlying network access.

3. The network of claim 2, wherein the highly interconnected overlay core routers are characterized by an interconnection ratio between said overlay core routers defined by:
$$D \geq \frac{2}{{N}_{C} - 1}$$
wherein:
$$D = \frac{T}{{T}_{C}}$$
with:
T the total number of links between the overlay core routers,
T_{C} the largest possible number of links between said overlay core
$${T}_{C} = \frac{{N}_{C} ( {N}_{C} - 1 )}{2}$$
routers, and N_{C} the number of overlay core routers.

4. The network of claim 3, wherein the overlay core routers are connected in full mesh so that D=1.

5. The network of claim 1, wherein each overlay edge router is connected to less than 4 overlay core routers.

6. The network of claim 5, wherein each overlay edge router is connected to exactly 2 overlay core routers.

7. The network of claim 6, wherein the overlay core routers are connected in full mesh so that D=1.

8. The network of claim 1, wherein the overlay core routers and the overlay edge routers are XML routers.

9. The network of claim 1, wherein the overlay network architecture is a proxy based overlay network.

10. The network of claim 1, wherein the underlying wide area network is an IP network.
